(19) United States
(12) Patent Application Publication
(10) Pub. No.: US 2025/0375779 A1
(43) Pub. Date: Dec. 11, 2025

(54) VARIABLE FLOW CONTROL NOZZLE FOR SWIMMING POOLS AND SPAS

(71) Applicant: ZODIAC POOL SYSTEMS LLC, Carlsbad, CA (US)

(72) Inventors: Quintin Buse, Carlsbad, CA (US); Dustin Borg, Poway, CA (US)

(73) Assignee: ZODIAC POOL SYSTEMS LLC, Carlsbad, CA (US)

(21) Appl. No.: 19/229,232

(22) Filed: Jun. 5, 2025

Related U.S. Application Data
(60) Provisional application No. 63/656,567, filed on Jun. 5, 2024.

(51) Int. Cl. B05B 1/30; E04H 4/12

(52) U.S. Cl. CPC B05B 1/3013; E04H 4/12

(57) ABSTRACT

A variable flow control nozzles for swimming pools and spas and associated methods may direct a flow (or jet) of water at a variable speed or variable flow rate. The variable flow control nozzles are self-adjusting and may automatically adjust and/or optimize the jet based on a flow rate of water supplied to the variable flow control nozzle.

### REFERENCE TO RELATED APPLICATION

This application claims the benefit of and priority to U.S. Provisional Patent Application No. 63/656,567, filed on Jun. 5, 2024, and entitled VARIABLE SPEED VARIABLE FLOW CONTROL NOZZLE FOR SWIMMING POOLS AND SPAS, the content of which is hereby incorporated by reference in its entirety.

### FIELD OF THE INVENTION

The invention relates to swimming pools and spas, and more particularly, but not limited to variable flow control nozzles or nozzles for swimming pools and spas.

### BACKGROUND OF THE INVENTION

Water of a swimming pool or spa may be circulated or otherwise directed to flow through various systems and/or pool equipment. As an example, a water circulation system may include a pump that draws water from the pool through a filtration system and returns the filtered water back to the pool through one or more return lines. Often the return lines include a variable flow control nozzle that the water is directed through such that the water is returned as a “jet” into the pool to promote mixing and distribution of the water. Traditionally, such variable flow control nozzles have included a fixed orifice or opening through which the water is directed to form the jet. Other pool equipment or applications that utilize fixed orifices to generate a jet of water include chemical tab feeders, skimmers, and centrifugal pre-filters, among other pool equipment and applications. Such traditional variable flow control nozzles and fixed orifices may adequately generate the jet when water is supplied to the variable flow control nozzle at a fixed flow rate. However, such traditional variable flow control nozzles are unable to accommodate varying or adjustable flow rates, often resulting in a build-up of backpressure within the system and/or the generation of a jet with inadequate performance.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a variable flow control nozzle may be configured to generate a jet of water, and the variable flow control nozzle is self-adjusting to control the jet of water via sliding or linear movement.

According to some embodiments, a self-adjusting variable flow control nozzle may be configured to generate a ring jet based on an input flow rate of water to the variable flow control nozzle.

According to various embodiments, a variable flow control nozzle may be configured to self-adjust based on an input flow rate to the variable flow control nozzle via sliding or linear movement.

According to certain embodiments, a variable flow control nozzle includes a housing defining an internal passage and a center support within the internal passage, and a nozzle face at least partially within the internal passage and arranged about the center support. In some cases, the nozzle face is self-adjusting.

According to some embodiments, a variable flow control nozzle includes a housing with an internal passage and a ring nozzle face within internal passage, and the ring nozzle face may be adjustable based on an input flow rate.

According to certain embodiments, a variable flow control nozzle includes a housing having a center support and a nozzle assembly on either side of the center support along a flow path through the variable flow control nozzle. In certain cases, the nozzle assembly is self-adjusting.

According to various embodiments, a variable flow control nozzle includes a housing with an inlet and an outlet, and a self-adjusting nozzle face may be retained at least partially within the housing between the inlet and the outlet. In certain cases, the nozzle face is self-adjusting based on an input flow rate.

According to some embodiments, a variable flow control nozzle may be configured to adjust an output jet from the variable flow control nozzle via sliding or linear movement of a nozzle face based on an input flow rate to the variable flow control nozzle.

According to various embodiments, a variable flow control nozzle may be configured to generate an output jet of water. In certain embodiments, the variable flow control nozzle may be adaptable based on an input flow rate of water to the variable flow control nozzle, and the variable flow control nozzle may include a biasing member biasing the variable flow control nozzle to a small opening state.

A self-adjusting variable flow control nozzle may be configured to receive input water flow and to generate a ring jet of water at a variable flow rate based on a flow rate of the input water flow.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 is a perspective view of a pool fitting of the pool system of FIG. 1 according to embodiments.

FIG. 3 is another perspective view of the pool fitting of FIG. 2 according to embodiments.

FIG. 4 is a sectional view and partial end view of the pool fitting of FIG. 2 according to embodiments.

FIG. 5 is a sectional view and partial end view of the pool fitting of FIG. 2 according to embodiments.

FIG. 6 is a sectional view and partial end view of the pool fitting of FIG. 2 according to embodiments.

FIG. 7 is another perspective view of the pool fitting of FIG. 2 according to embodiments.

FIG. 8 is another perspective view of the pool fitting of FIG. 2 according to embodiments.

FIG. 9 is a sectional view of the pool fitting of FIG. 2 according to embodiments.

FIG. 10 is another perspective view of the pool fitting of FIG. 2 according to embodiments.

FIG. 11 is another perspective view of the pool fitting of FIG. 2 according to embodiments.

FIG. 12 is another sectional view of the pool fitting of FIG. 2 according to embodiments.

FIG. 13 is another sectional view of the pool fitting of FIG. 2 according to embodiments.

FIG. 14 illustrates the pool fitting of FIG. 2 further including a flanged portion according to embodiments.

FIG. 15 is a side view of the pool fitting of FIG. 2 according to embodiments.

### DETAILED DESCRIPTION

Described herein are variable flow control nozzles for swimming pools and spas and associated methods for directing a flow (or jet) of water at a variable speed or variable flow rate. In certain embodiments, the variable flow control nozzles described herein are self-adjusting and automatically adjust and/or optimize the jet based on a flow rate of water supplied to the variable flow control nozzle. In some embodiments, the variable flow control nozzles described herein may receive input water flow and generate a ring jet of water at different flow rates based on a flow rate of the input water flow. In certain embodiments, the variable flow control nozzles described herein are self-adjusting to control a jet of water via sliding or linear movement.

In various embodiments, variable flow control nozzles described herein may include a housing defining an internal passage, a center support within the internal passage, and a nozzle face at least partially within the internal passage and arranged about the center support. In some embodiments, variable flow control nozzles described herein include a housing with an internal passage and a ring nozzle face within the internal passage, and the ring nozzle face is adjustable based on an input flow rate. In various embodiments, variable flow control nozzles described herein may generate an output jet of water based on an input flow rate of water to the variable flow control nozzle, and the variable flow control nozzle optionally includes a biasing member biasing the variable flow control nozzle to a small opening state.

The variable flow control nozzles described herein may be used in various pool equipment and/or with various pool applications as desired. As non-limiting examples, the variable flow control nozzles described herein may be return line fittings, pool fittings, a variable flow control nozzle for a chemical feeder (such as but not limited to a chemical erosion feeder), a variable flow control nozzle for a skimmer, a fitting for a centrifugal pre-filter, combinations thereof, and/or as otherwise desired.

In one non-limiting example, the variable flow control nozzle is a return fitting for a water circulation system of a swimming pool or spa. In such embodiments, the variable flow control nozzle may adjust the jet of water based on a varying flow rate from a pump (e.g., a variable speed pump), which may optimize the mixing performance of water returning to the pool. In certain embodiments, the variable flow control nozzle may optimize (e.g., maximize) mixing performance of the jet at low flow rates and may reduce backpressure on the system at high flow rates.

In another non-limiting example, the variable flow control nozzle is an adjustable nozzle for an erosion tab feeder, and the variable flow control nozzle may adjust and control backpressure through the erosion tab feeder based on a flow rate supplied by a pump.

In yet another non-limiting example, the variable flow control nozzle may be utilized with a skimmer, such as but not limited to a venturi skimmer. In such embodiments, the variable flow control nozzle may maximize velocity of the jet at low flow rates and decrease backpressure at high flow rates compared to fixed orifices traditionally utilized.

In a further non-limiting example, the variable flow control nozzle may be utilized with a centrifugal pre-filter. In such embodiments, the variable flow control nozzle may adjust the jet based on the input flow rate to provide a desired water velocity required for proper performance of the centrifugal pre-filter.

Various other benefits and advantages may be realized with the systems, devices, and methods provided herein, and the aforementioned advantages should not be considered limiting.

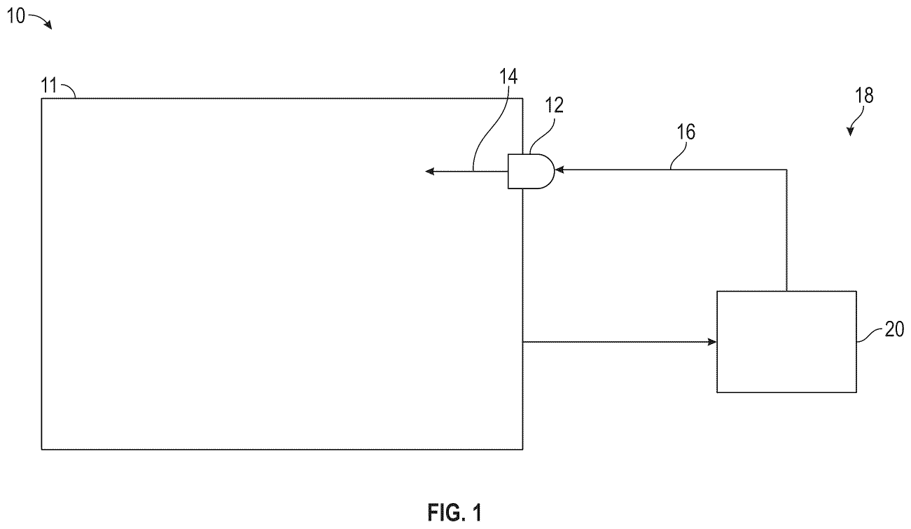

FIG. 1 illustrates a pool system 10 according to embodiments. As illustrated in FIG. 1, the pool system 10 generally includes a pool or spa (hereinafter “pool 11”) and one or more variable flow control fittings or nozzles 12 (hereinafter “variable flow control nozzle 12”), which may generate a jet 14 of water based on an input flow 16 of water to the variable flow control nozzle 12. In the embodiment illustrated in FIG. 1, the variable flow control nozzle 12 is provided as a return line fitting or a return line nozzle for a circulation system 18 which circulates water via one or more pumps 20. However, in other embodiments, the variable flow control nozzle 12 may be provided with other equipment or systems for the pool system 10 as desired and is not limited to a return line fitting or nozzle. As non-limiting examples, variable flow control nozzles 12 described herein additionally, or alternatively, may be provided with a chemical dosing system for the pool system 10, such as but not limited to an erosion tab feeder, may be provided with a skimmer, such as but not limited to a venturi skimmer, may be provided with a filter system, such as but not limited to a centrifugal pre-filter, combinations thereof, and/or with other equipment or systems as desired.

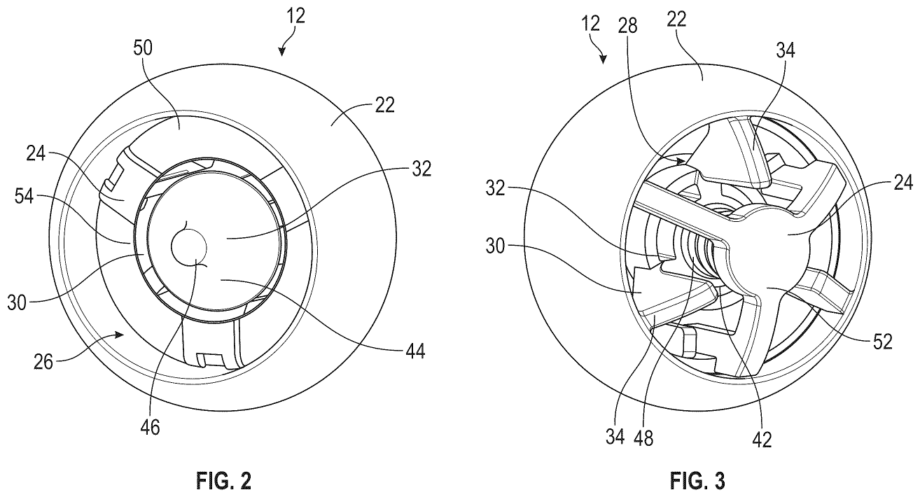

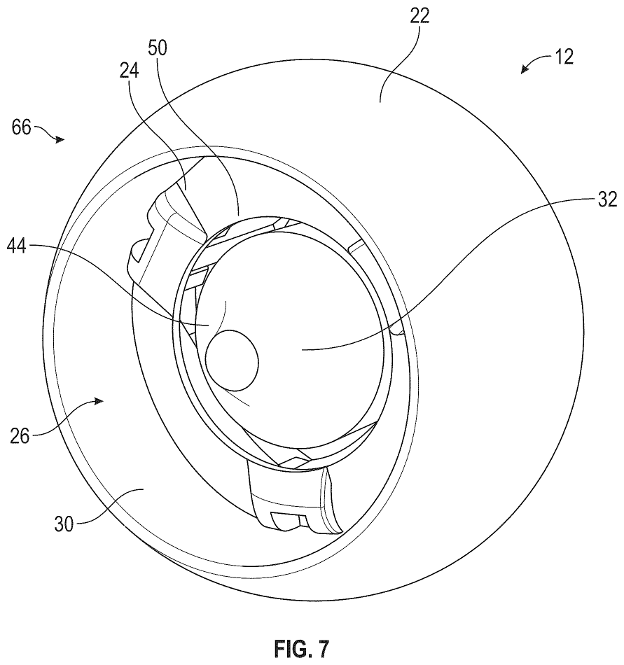

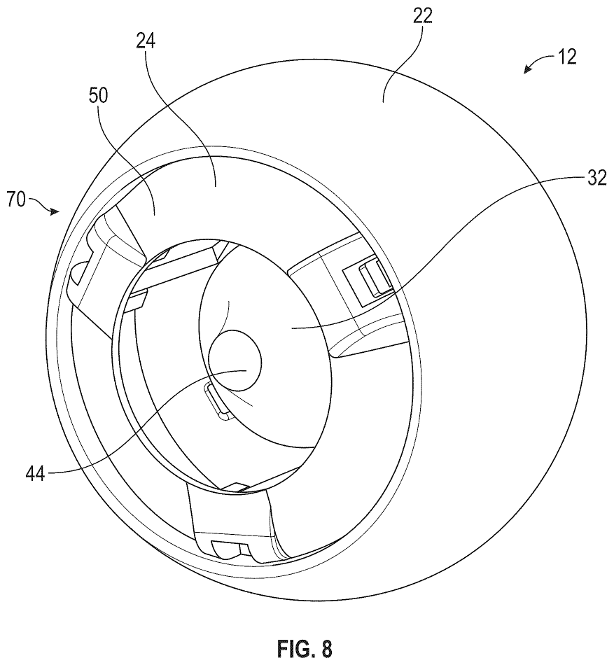

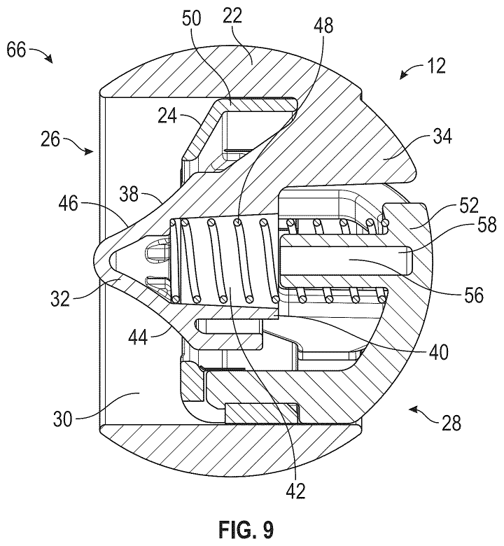

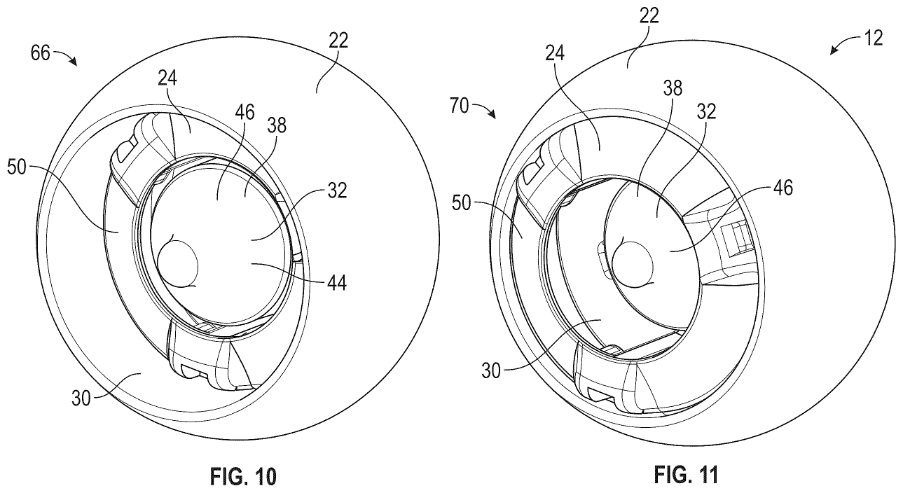

FIGS. 2-15 illustrate the variable flow control nozzle 12 in greater detail and according to embodiments. As illustrated, the variable flow control nozzle 12 generally includes a housing 22 and a nozzle assembly 24.

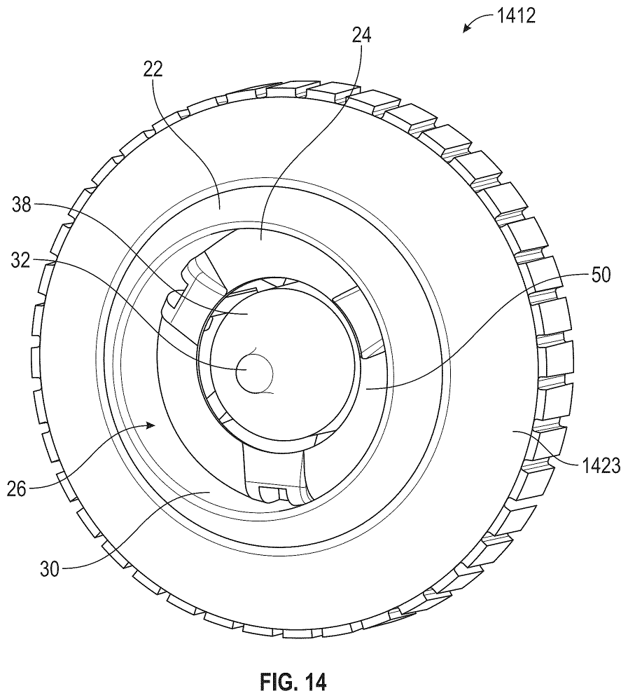

The housing 22 of the variable flow control nozzle 12 may be constructed from various materials as desired and may have various shapes or profiles as desired. As such, the particular shape or profile of the housing 22 illustrated should not be considered limiting. As non-limiting examples, FIGS. 2-13 and 15 illustrate the housing 22 with a generally domed shape while FIG. 14 illustrates a variable flow control nozzle 1412 that is substantially similar to the variable flow control nozzle 12 of FIGS. 2-13 and 15 except that a housing 22 of the variable flow control nozzle 1412 is positioned within a flanged portion 1423. In some embodiments, the flanged portion 1423 is a component of the housing 22; however, in other embodiments, the flanged portion 1423 may be a separate part or component in which the housing 22 is positioned.

In some embodiments, the housing 22 may be shaped to facilitate orientation of the housing 22 (and thus the orientation of the variable flow control nozzle 12) when installed and without requiring disassembly of the variable flow control nozzle 12. As a non-limiting example, the housing 22 may be in the form of a rotatable “eyeball” which can be rotated into a desired orientation to direct the jet 14 of water in a particular direction, towards a particular area, and/or as otherwise desired. In such embodiments, and as illustrated in FIGS. 2-13 and 15, the housing 22 may have an arcuate and/or non-linear side surface. However, in other embodiments, the housing 22 may have other shapes as desired. Moreover, in other embodiments, the housing 22 may be oriented via other systems or mechanisms as desired.

Regardless of the particular shape of the housing 22, the housing 22 of the variable flow control nozzle 12 generally includes an inlet 28, an outlet 26, and an internal passage 30 extending therebetween. In various embodiments, when the variable flow control nozzle 12 is provided with pool equipment and/or a pool application, the variable flow control nozzle 12 is arranged such that the inlet 28 may receive the input flow of water 16 and the variable flow control nozzle 12 may direct the jet 14 of water from the outlet 26.

In certain embodiments, the housing 22 includes a center support 32 at least partially within the internal passage 30. In some embodiments, one or more extensions 34 extending from an inner surface 36 of the internal passage 30 may position the center support 32 within the internal passage 30. However, in other embodiments, other features or combinations of features may be utilized to position the center support 32, and the extensions 34 need not be included.

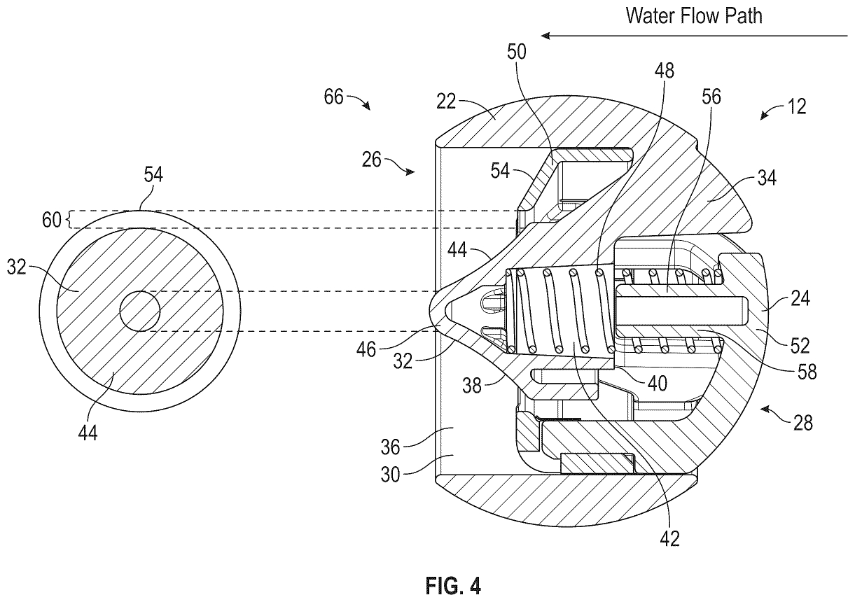

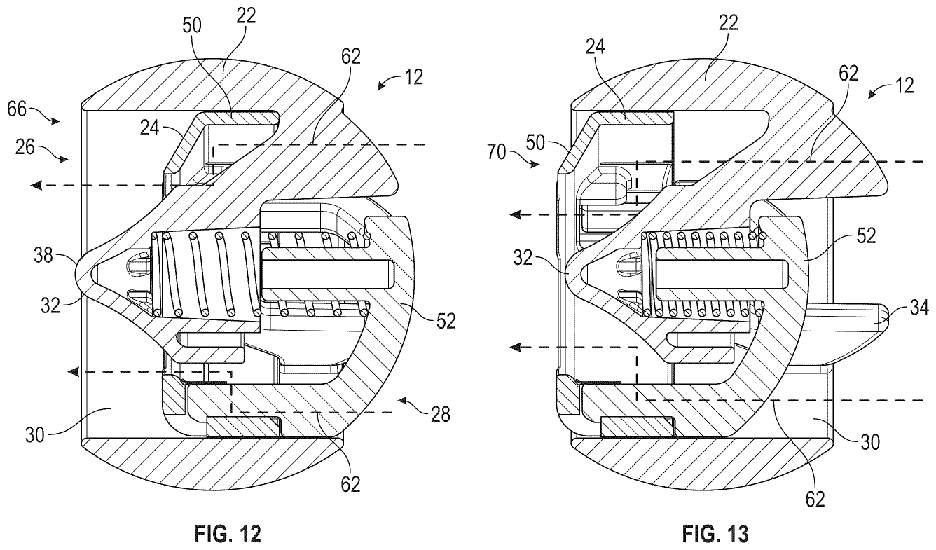

As illustrated in FIGS. 4-6, for example, the center support 32 generally includes an inlet side 40 and an outlet side 38. In some embodiments, the inlet side 40 may be defined a cavity 42 for receiving a biasing member 48 and/or at least a portion of the nozzle assembly 24 as discussed in detail below. An opening area 44 of the variable flow control nozzle 12 is defined between an outlet side surface 46 of the outlet side 38 and the nozzle assembly 24. In use, water is directed from the inlet 28 and through the opening area 44 (see arrows 62 in FIGS. 12 and 13) to generate the jet 14 of water exiting the outlet 26. As discussed in greater detail below, the nozzle assembly 24 may be self-adjusting and/or automatically adjustable such that the jet 14 is automatically adjusted based on the input flow of water.

In some embodiments, the outlet side 38 optionally may include one or more surface features 46 for at least partially controlling the jet formed by the opening area 44. Non-limiting examples of surface features 46 include, but are not limited to, a radiused tip or nose, an angled tip or nose, ribs, grooves, combinations thereof, and/or other features or combinations of features as desired.

The nozzle assembly 24 of the variable flow control nozzle 12 generally includes a nozzle face 50 and a connecting portion 52. In some embodiments, the nozzle face 50 and the connecting portion 52 are arranged relative to the center support 32 such that the center support 32 is at least partially between the nozzle face 50 and the connecting portion 52. In various embodiments, the nozzle face 50 and the connecting portion 52 are coupled to each other (see, e.g., FIGS. 4-6) and on opposing sides of the center support 32, thereby retaining the nozzle assembly 24 on the center support 32. In some embodiments, and as illustrated in FIGS. 4-6, for example, the nozzle face 50 and the connecting portion 52 may be separate components coupled together using various devices, techniques, or mechanisms as desired. In the embodiment illustrated, the nozzle face 50 and connecting portion 52 are connected via a snap-fit connection; however, in other embodiments, other mechanisms or techniques may be utilized as desired, such as but not limited to clips, clasps, friction fit features, hook and loop fasteners, mechanical fasteners, combinations thereof, and/or other suitable mechanisms as desired. Moreover, while FIGS. 4-6 illustrate the nozzle face 50 and connecting portion 52 as separate components that are couplable together, in other embodiments, the nozzle face 50 and connecting portion 52 need not be separate components and instead may be monolithically or integrally formed.

As illustrated in FIGS. 4-6, for example, the nozzle face 50 of the nozzle assembly 24 may be arranged more proximate to the outlet 26 of the variable flow control nozzle 12 and the connecting portion 52 of the nozzle assembly 24 may be arranged more proximate to the inlet 28 of the variable flow control nozzle 12. In some embodiments, the nozzle face 50 is at least partially on the outlet side 38 of the center support 32 and the connecting portion 52 is at least partially on the inlet side 40 of the center support 32.

Referring to FIGS. 4-6, the nozzle face 50 of the nozzle assembly 24 defines the opening area 44 together with the outlet side 38 of the center support 32. In certain embodiments, the nozzle face 50 is arranged relative to the center support 32 such that nozzle face 50 and the center support 32 generate a ring jet of water. In this regard, and as best illustrated in FIG. 2, in some embodiments the nozzle face 50 may have an annular or ring shape. However, in other embodiments, the nozzle face 50 may have other shapes as desired and/or may generate jets of water with other shapes that need not be a ring shape. Optionally, and as illustrated in FIGS. 4-6, a control portion 54 of the nozzle face 50 may be angled inwards and/or otherwise shaped to promote generation and control of the jet of water.

As illustrated in FIG. 4, in certain embodiments, the connecting portion 52 of the nozzle assembly 24 may include a positioning feature 56. When included, the positioning feature 56 may facilitate positioning of the connecting portion 52 relative to the center support 32 and/or may facilitate the control of movement of the nozzle assembly 24 relative to the center support 32 when the nozzle assembly 24 is adjusted to various states as described in detail below. In the embodiment illustrated, the connecting portion 52 is a post extension 58; however, in other embodiments, other features or mechanisms may be utilized as the positioning feature 56.

In certain embodiments, and illustrated in FIGS. 4-6, 9, 12, and 13, the positioning feature 56 additionally or alternatively may support and/or position the biasing member 48 relative to the nozzle assembly 24. In addition to being positioned relative to the nozzle assembly 24, the biasing member 48 may be supported and/or positioned relative to the center support 32. In some embodiments, the biasing member 48 is positioned at least partially within the cavity 42. The biasing member 48 may be various suitable devices applying a biasing force on the nozzle assembly 24 for applying a force or pressure to the nozzle assembly 24 and controlling movement and/or maintaining a specific positioning of the nozzle assembly 24 relative to the housing 22 in the absence of an external force. Non-limiting examples of the biasing member 48 may include, but are not limited to, various springs, compression members, elastic materials, combinations thereof, and/or other suitable biasing members. In some embodiments, and as discussed in detail below, the biasing member 48 may bias the nozzle assembly 24 to a small opening state (see, e.g., FIGS. 4 and 12).

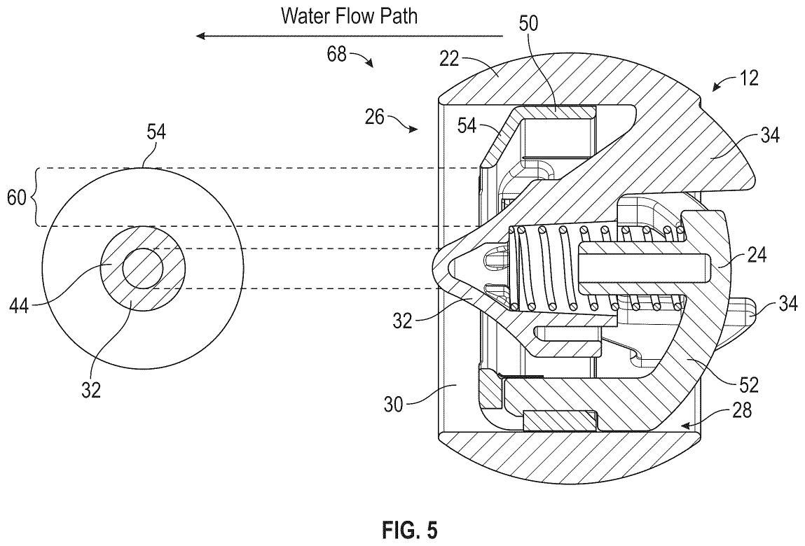

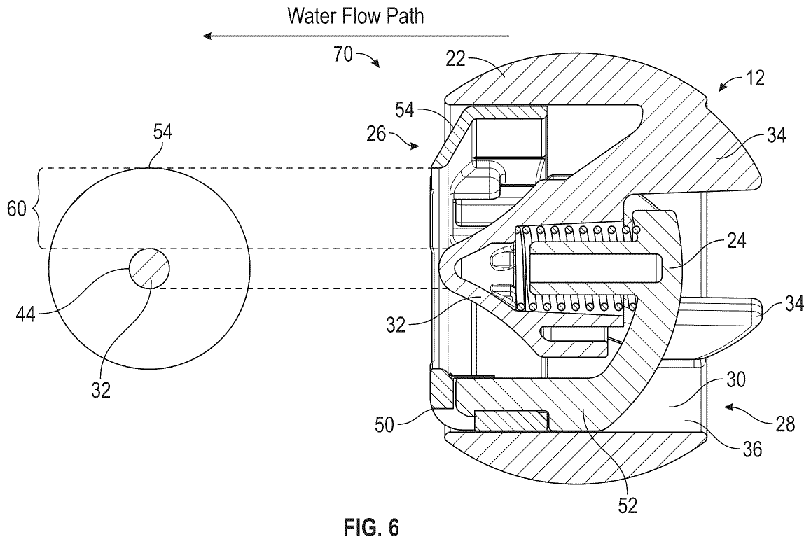

As best illustrated by comparing FIGS. 4-6 and as also illustrated by comparing FIGS. 12 and 13, the nozzle assembly 24 is movable relative to the housing 22 and the center support 32 such that a size 60 of the opening area 44 is adjustable between a plurality of configurations or states. In certain embodiments, the plurality of states may include a small opening state 66 (see, e.g., FIGS. 4 and 12), one or more intermediate opening states 68 (FIG. 5), and a large opening state 70 (see, e.g., FIGS. 6 and 13). In various embodiments, and as described in detail below, depending on the state of the nozzle assembly 24, a size 60 of the opening area 44 for forming the jet of water may be controlled.

In various embodiments and as illustrated in FIGS. 4 and 12, in the small opening state 66, the size 60 of the opening area 44 defined by the variable flow control nozzle 12 may be at a minimum. In some embodiments, a baseline state of the nozzle assembly 24 may be the small opening state 66 (e.g., in the absence of an external force or pressure, the nozzle assembly 24 may be positioned in the small opening state 66). As illustrated in FIGS. 6 and 13, in the large opening state 70, the size 60 of the opening area 44 defined by the variable flow control nozzle 12 may be at a maximum. In the one or more intermediate opening states 68, the size 60 of the opening area 44 may be an intermediate size greater than the small opening state 66 and less than the large opening state 70 as illustrated in FIG. 5.

In certain embodiments, the nozzle assembly 24 is linearly movable and/or slidable relative to the housing 22 and the center support 32 to be in one of the flow states 66, 68, 70. In certain embodiments, the biasing member 48 applying the biasing force may bias the nozzle assembly 24 to the small opening state 66. The nozzle assembly 24 with the biasing member 48 may be automatically adjustable relative to the flow or backpressure of water entering the nozzle assembly 24. As non-limiting examples, in the small opening state 66, the backpressure and/or flow rate of water entering the variable flow control nozzle 12 is insufficient to overcome the biasing force applied by the biasing member 48, and the nozzle assembly 24 is biased into and is maintained in the small opening state 66 with the opening area 44 having the minimum size 60. In the intermediate opening state(s) 68, the backpressure and/or flow rate of water entering the variable flow control nozzle 12 may partially overcome the biasing force from the biasing member 48 such that the nozzle face 50 is partially moved towards the inlet 28, thereby increasing the size of the opening area 44. In the large opening state 70, the backpressure and/or flow rate of water entering the variable flow control nozzle 12 may be at a maximum, thereby overcoming the biasing force and moving the nozzle assembly 24 such that the opening area 44 has a maximum size.

While FIGS. 4-6 illustrate static positions of the nozzle assembly 24, the position of the nozzle assembly 24 may be adaptable in real time to control the size of the opening area 44 to provide an optimized jet of water from the variable flow control nozzle 12. Relatedly, the time at which the nozzle assembly 24 is in a particular state 66, 68, 70 need not be set, and the nozzle assembly 24 may be in and/or transition through various states 66, 68, 70 responsive to the flow rate and/or backpressure of water at the inlet 28. As a non-limiting example, responsive to a spike in flow rate and/or backpressure of water at the inlet 28, the nozzle assembly 24 may transition from the small opening state 66 directly to the large opening state 70 (e.g., with minimal time in the transitional state 68) before returning to the transitional state 68 and/or the small opening state 66 once the spike has passed. As another non-limiting example, the nozzle assembly 24 may respond to a change in flow rate and/or backpressure caused by a change in speed of a variable speed pump of the pool system 10. Other linear and/or sliding movement of the nozzle assembly 24 responsive to the flow rate and/or backpressure may be implemented as desired.

FIG. 14 illustrates a variable flow control nozzle 1412 with a housing 22 and a flanged portion 1422. In particular, compared to the housing 22, the flanged portion 1423 outwards from the housing 22 in FIG. 14. In some embodiments, the flanged portion 1423 is a portion of the housing 22. In other embodiments, and as illustrated in FIG. 14, the flanged portion 1423 is a separate part or component in which the housing 22 is positioned. In other embodiments, variable flow control nozzles described herein may have other shapes or sizes as desired.

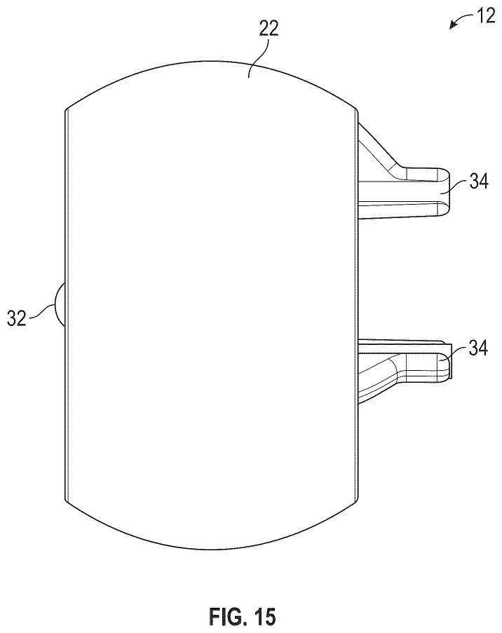

In some embodiments, and referring to FIG. 15, the variable flow control nozzle 12 optionally includes one or more rotation limiting features 1525. In certain embodiments, the rotation limiting features 1525 may limit and/or define a range of rotation or pivoting of the housing 22. As non-limiting examples, the rotation limiting features 1525 may limit rotation of the housing 22 such that the housing 22 does not rotation 180° (e.g., such that the inlet and outlet are reversed). In other embodiments, other ranges of rotation may be defined by the rotation limiting features 1525 as desired. The rotation limiting features 1525 may be various devices or mechanisms suitable for limiting and/or defining a range of rotation of the housing 22. In the embodiment illustrate, the rotation limiting features 1525 are one or more posts 1527 extending outwards from the outlet 26. Other devices or mechanisms may be utilized as desired.

Compared to traditional variable flow control nozzles with fixed restrictions, the variable flow control nozzle 12 described herein may adapt to various flow rates, thereby optimizing the jet generated by the variable flow control nozzle 12 for pool applications, including in equipment, not just return fittings for mixing pool water. In some embodiments, the variable flow control nozzle 12 may generate the jet of water with a size, flow rate, and/or backpressure optimized for agitating water of the pool 11, returning water to the pool 11, generating an effective venturi jet for a skimmer even at low flows, generating a high velocity for filtering, combinations thereof, and/or as otherwise desired.

Various other benefits and advantages may be realized with the systems, devices, and methods provided herein, and the aforementioned advantages should not be considered limiting.

Exemplary concepts or combinations of features of the invention may include:
A. A variable flow control nozzle configured to generate a jet of water, wherein the variable flow control nozzle is self-adjusting to control the jet of water via sliding or linear movement.
B. A self-adjusting variable flow control nozzle configured to generate a ring jet based on an input flow rate of water to the variable flow control nozzle.
C. A variable flow control nozzle configured to self-adjust based on an input flow rate to the variable flow control nozzle via sliding or linear movement.
D. A variable flow control nozzle comprising:
   i. a housing defining an internal passage and a center support within the internal passage; and
   ii. a nozzle face at least partially within the internal passage and arranged about the center support, wherein the nozzle face is self-adjusting.
E. A variable flow control nozzle comprising a housing with an internal passage and a ring nozzle face within internal passage, wherein the ring nozzle face is adjustable based on an input flow rate.
F. A variable flow control nozzle with a housing having a center support and a nozzle assembly on either side of the center support along a flow path through the variable flow control nozzle, wherein the nozzle assembly is self-adjusting.
G. A variable flow control nozzle comprising a housing with an inlet and an outlet, and a self-adjusting nozzle face retained at least partially within the housing between the inlet and the outlet, wherein the nozzle face is self-adjusting based on an input flow rate.
H. A variable flow control nozzle configured to adjust an output jet from the variable flow control nozzle via sliding or linear movement of a nozzle face based on an input flow rate to the variable flow control nozzle.
I. A variable flow control nozzle configured to generate an output jet of water, wherein the variable flow control nozzle is adaptable based on an input flow rate of water to the variable flow control nozzle, and wherein the variable flow control nozzle comprises a biasing member biasing the variable flow control nozzle to a small opening state.
J. The variable flow control nozzle of any preceding or subsequent statements or combination of statements, wherein, at a minimal flow rate, the nozzle face is within the housing.
K. The variable flow control nozzle of any preceding or subsequent statements or combination of statements, further comprising a biasing member applying a biasing force to the nozzle assembly.
L. The variable flow control nozzle of any preceding or subsequent statements or combination of statements, wherein the variable flow control nozzle is self-adjusting between a large opening state and a small opening state, wherein a size of an opening area of the variable flow control nozzle in the large opening state is greater than the size of the opening area in the small opening state, and wherein the biasing member biases the nozzle assembly to a small opening state.
M. The variable flow control nozzle of any preceding or subsequent statements or combination of statements, wherein the biasing member biases the nozzle assembly to a minimal opening area.
N. The variable flow control nozzle of any preceding or subsequent statements or combination of statements, wherein the variable flow control nozzle is a nozzle.
O. The variable flow control nozzle of any preceding or subsequent statements or combination of statements, wherein the variable flow control nozzle is a return line fitting for a return line of a pool system.
P. The variable flow control nozzle of any preceding or subsequent statements or combination of statements, further comprising a rotation limiting feature configured to limit and/or define a range of rotation of the housing.
Q. The variable flow control nozzle of any preceding or subsequent statements or combination of statements, wherein the rotation limiting feature prevents a 180° rotation of the housing in which the inlet and outlet would be reversed.
R. Pool equipment comprising the variable flow control nozzle of any preceding or subsequent statements or combination of statements.
S. Pool equipment of any preceding or subsequent statement or combination of statements, wherein the pool equipment comprises an erosion tab feeder, a skimmer, or a centrifugal filter.
T. A pool system comprising a water circulation system comprising the variable flow control nozzle of any preceding or subsequent statements or combination of statements.
U. A self-adjusting variable flow control nozzle configured to receive input water flow and to generate a ring jet of water at a variable flow rate based on a flow rate of the input water flow.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools or spas, persons skilled in the relevant field will recognize that the present invention conceivably could be employed in connection with other water containing vessels and in other manners, particularly but not limited to underwater installations. Finally, references to “pools” and “swimming pools” herein may also refer to spas or other water containing vessels used for recreation, training, or therapy.

That which is claimed:

1. A variable flow control nozzle for a pool or spa, wherein the variable flow control nozzle comprises means for generating a jet of water, wherein the variable flow control nozzle is self-adjusting to control the jet of water via sliding or linear movement.

2. The variable flow control nozzle of claim 1, wherein the variable flow control nozzle is self-adjusting based on an input flow rate of water to the variable flow control nozzle.

3. The variable flow control nozzle of claim 1, wherein the variable flow control nozzle comprises:
a housing defining an internal passage and a center support within the internal passage; and
a nozzle face at least partially within the internal passage and arranged about the center support, wherein the nozzle face is self-adjusting.

4. The variable flow control nozzle of claim 3, wherein, at a minimal flow rate, the nozzle face is within the housing.

5. The variable flow control nozzle of claim 1, further comprising a biasing member applying a biasing force to a nozzle assembly of the variable flow control nozzle.

6. The variable flow control nozzle of claim 5, wherein the biasing member biases the nozzle assembly to a small opening state.

7. The variable flow control nozzle of claim 5, wherein the biasing member biases the nozzle assembly to a minimal opening area.

8. Pool equipment comprising the variable flow control nozzle of claim 1, wherein the pool equipment comprises an erosion tab feeder, a skimmer, or a centrifugal filter.

9. A variable flow control nozzle comprising a housing with a center support and a nozzle assembly on either side of the center support along a flow path through the variable flow control nozzle, wherein the nozzle assembly is self-adjusting.

10. The variable flow control nozzle of claim 9, wherein the variable flow control nozzle is self-adjusting between a large opening state and a small opening state, wherein a size of an opening area of the variable flow control nozzle in the large opening state is greater than the size of the opening area in the small opening state, and wherein the variable flow control nozzle comprises a biasing member biasing the variable flow control nozzle to the small opening state.

11. The variable flow control nozzle of claim 9, wherein the nozzle assembly is self-adjusting between a large opening state and a small opening state, and wherein, in the small opening state, a nozzle face of the nozzle assembly is within the housing.

12. The variable flow control nozzle of claim 9, further comprising a biasing member applying a biasing force to the nozzle assembly.

13. The variable flow control nozzle of claim 9, wherein the nozzle assembly comprises a nozzle face and a connecting portion, wherein the nozzle face is on a first side of the center support and the connecting portion is on a second side of the second support.

14. The variable flow control nozzle of claim 9, wherein the nozzle assembly is self-adjusting via sliding or linear movement.

15. A variable flow control nozzle comprising a housing with an inlet and an outlet, and a self-adjusting nozzle face retained at least partially within the housing between the inlet and the outlet, wherein the nozzle face is self-adjusting based on an input flow rate.

16. The variable flow control nozzle of claim 15, wherein the housing further comprises a center support and a nozzle assembly comprising the self-adjusting nozzle face and a connecting portion on either side of the center support along a flow path through the variable flow control nozzle.

17. The variable flow control nozzle of claim 15, further comprising a biasing member applying a biasing force for positioning the nozzle face.

18. The variable flow control nozzle of claim 15, wherein the nozzle assembly is self-adjusting via sliding or linear movement.

19. The variable flow control nozzle of claim 15, further comprising a rotation limiting feature configured to limit and/or define a range of rotation of the housing.

20. The variable flow control nozzle of claim 19, wherein the rotation limiting feature prevents a 180° rotation of the housing in which the inlet and outlet would be reversed.
